(19) United States
(12) Patent Application Publication
(10) Pub. No.: US 2012/0198685 A1
(43) Pub. Date: Aug. 9, 2012

(54) METHOD TO PRODUCE AN ELECTRODE WITH A LOW LEVEL OF HYDROGEN AND LOW ABSORPTION OF MOISTURE

(76) Inventor: Aurecyl Dalla Bernardina Junior, Contagem -MG (BR)

(21) Appl. No.: 13/383,326

(22) PCT Filed: Oct. 6, 2011
(86) PCT No.: PCT/BR11/00379

§ 371 Date: Jan. 10, 2012

(30) Foreign Application Priority Data
Oct. 7, 2010 (BR) PI 1003876-0

(51) Int. Cl. B23K 35/40

(52) U.S. Cl. 29/527.4

(57) ABSTRACT

Consists of a method to produce a electrode coated with chemical elements that provide reactivity with moisture in the electric arc, eliminates water (H₂O) by chemical reaction, reducing the level of hydrogen (H₂) drastically in soldering metal, using a temperature if 360°, in the curing oven for five minutes to cure the polymer, maintain the physical and chemical properties of electrodes with low levels of hydrogen, reactive with any residual moisture, with no need to pretreat the electrode before its use.

This patent refers to a method used in the field of industrial welding, more particularly targeting the production of electrodes with a coating that, through chemical reactions with moisture, decreases the hydrogen content and presents characteristics of low moisture absorption, reducing drying time, which will generate savings during its production.

Currently, electrodes used in the field of industrial welding consist of a cut piece of wire, a dry mixture, a silicate containing water (H₂O), a wet mixture, a drying oven at a temperature of 400 degrees C. with a duration of nine hours in order to eliminate the water (H₂O) and decrease the hydrogen (H₂). After the cure time the electrodes are packaged in an appropriate manner.

Another process uses a cut wire, a dry mixture, a polymer, a solvent and a wet mixture; it does not use an oven for drying, but instead the components are left in the open air to evaporate the solvent and cure the polymer.

All the materials to be added for this purpose are of mineral origin, which have high decomposition temperatures, which hampers the reaction with the moisture in the air and the moisture generated by the combustion thereof.

In order to minimize the financial costs and to optimize production time, this process was developed in order to improve the characteristics of the soldering metal, through the addition of halogenated organic compounds in the form of polymers, which because of their low decomposition temperature react with the water remaining in the electric arc, reducing the level of diffuse hydrogen drastically.

This process consists of a cut wire, a homogenization conforming to the dry mixture, a polymer that has halogen atoms in its structure, a wet mixture, and an oven at a temperature of 360° C. for five minutes to cure the polymer. After the polymer has cured, the electrodes are sent directly to quality control and packaged in metal cans, plastic cases, or other similar types of packages.

The electrodes produced save raw materials and it becomes unnecessary to make sure they are re-dried and preserved in ovens, since they react with any residual moisture, and can be used in the rain or even while soldering underwater, are flexible and can be bent without damaging the coating, which has a high mechanical strength, low levels of hydrogen, while maintaining the same physical, chemical and metallurgical properties of the ordinary electrodes produced by conventional processes.

1. METHOD TO PRODUCE AN ELECTRODE WITH A LOW LEVEL OF HYDROGEN AND LOW ABSORPTION OF MOISTURE, which after the preparation and cutting of the wire into standardized sizes, characterized by using a dry mixture, a polymer with halogens included within its molecular structure, and a wet mixture.

2. METHOD TO PRODUCE AN ELECTRODE WITH A LOW LEVEL OF HYDROGEN AND ABSORPTION OF MOISTURE, in accordance with claim 1, characterized in that it uses a curing oven at a temperature of 360° for approximately five minutes, to promote curing of the polymer and elimination of water (H₂O) through a chemical reaction, reducing the hydrogen (H₂), maintain the properties of the common electrode, being also reactive with moisture.
